(19) United States
(12) Patent Application Publication
(10) Pub. No.: US 2004/0151531 A1
(43) Pub. Date: Aug. 5, 2004

(54) Sound deadening mechanism for a ring binder

(75) Inventors: Stephen P. Corr, Gurnee, IL (US); Alvin C. Skat JR., Elmhurst, IL (US); Paul Hatch, Chicago, IL (US); Chris Barmore, Chicago, IL (US); Philip M. Anthony III, Chicago, IL (US); Aaron B. Eiger, Chicago, IL (US)

Correspondence Address: Kevin P. Moran, Michael Best & Friedrich LLP, 100 East Wisconsin Avenue, Milwaukee, WI, 53202-4108, US

(73) Assignee: ACCO Brands, Inc., Lincolnshire, IL

(21) Appl. No.: 10/355,414

(22) Filed: Jan. 31, 2003

(51) Int. Cl. B42F 13/00

(52) U.S. Cl. 402/26

(57) ABSTRACT

A binder including a flat and a ring mechanism coupled to a mounting surface of the flat. The ring mechanism includes a chassis and a hinge blade coupled to the chassis. The hinge blade is movable between a first and a second position. A ring half is coupled to the hinge blade, the ring half movable between a closed position, when the hinge blade is in the first position, and an open position, when the hinge blade is in the second position. A sound deadening mechanism in the form of a dampening member is positioned at least partially between the chassis and the mounting surface to prevent the hinge blade from directly engaging the inner surface of the chassis.

### FIELD OF THE INVENTION

The invention relates to ring binders, and more particularly to ring mechanisms in ring binders.

### BACKGROUND OF THE INVENTION

Ring binders employ a ring mechanism that is movable between a closed position and an open position to allow a user to insert documents into the binder and securely store them. However, known ring mechanisms tend to be noisy, producing a loud clicking sound when the ring mechanism is moved between the closed and the open positions.

### SUMMARY OF THE INVENTION

The present invention provides a sound deadening mechanism for use in a ring mechanism to substantially reduce the noise made when the ring mechanism is moved between the closed and the open positions. More specifically, the invention provides a ring mechanism that includes a chassis having an inner surface and a hinging element that is comprised of a hinge blade coupled to the chassis. The hinge blade is movable between a first position and a second position. A ring half is coupled to the hinge blade. The ring half is movable between a closed position, when the hinge blade is in the first position, and an open position, when the hinge blade is in the second position. A dampening member is positioned at least partially between the inner surface of the chassis and the hinge blade to prevent the hinge blade from directly engaging the inner surface of the chassis.

In one embodiment of the invention, the ring mechanism includes two hinge blades hinged about a hinge axis and the dampening member is at least partially positioned on the hinge axis. In another embodiment of the invention, the dampening member is a longitudinally extending member having longitudinally extending grooves. In yet another embodiment of the invention, the dampening member is a substantially cylindrical member having a circumferential groove. In another embodiment of the invention, the ring mechanism comprises a post coupled to the chassis and the dampening member is a washer coupled to the post.

The ring mechanism can be coupled to the flat on a mounting surface, generally on the spine or the panel of the flat. A dampening member can be positioned between the mounting surface of the flat and the hinge blade to further muffle the sound generated when the binder mechanism is moved between the closed and the open position.

The above-described ring mechanism can be used to practice a method of dampening sound in a ring mechanism. The method includes positioning a dampening member between the inner surface of the chassis and the mounting surface of the flat. The method also includes moving the hinge blade between the first and second positions so that the dampening member substantially prevents at least a portion of the hinge blade from directly engaging the inner surface of the chassis when the hinge blade is moved to at least one of the first and second positions.

In one embodiment of the invention, the method includes positioning the dampening member at least partially between the inner surface of the chassis and the hinge blade. In another embodiment of the invention, the method includes positioning the dampening member at least partially between the mounting surface of the flat and the hinge blade.

Other features and advantages of the invention will become apparent to those skilled in the art upon review of the following detailed description, claims, and drawings.

### BRIEF DESCRIPTION OF THE DRAWINGS

FIG. 1 is a perspective view of a ring binder embodying the present invention.

FIG. 2 is a perspective view of a ring mechanism having a sound deadening mechanism embodying the invention.

FIG. 3 is a cross-sectional view taken along line 3-3 of FIG. 2 showing the ring mechanism in the closed position.

FIG. 4 is the cross-sectional view of FIG. 3 showing the ring mechanism in the open position.

FIG. 5 is a perspective view of a ring mechanism with a second embodiment of a sound deadening mechanism embodying the invention.

FIG. 6 is a perspective view of the sound deadening mechanism of FIG. 5.

FIG. 7 is an enlarged perspective view, partially cut-away of a ring mechanism with a third embodiment of a sound deadening mechanism embodying the invention.

FIG. 8 is a cross-sectional view taken along line 8-8 of FIG. 7 showing the ring mechanism in the closed position.

FIG. 9 is the cross-sectional of FIG. 8 showing the ring mechanism in the open position.

FIG. 10 is a partial perspective view of a ring mechanism with a fourth embodiment of a sound deadening mechanism embodying the invention.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION

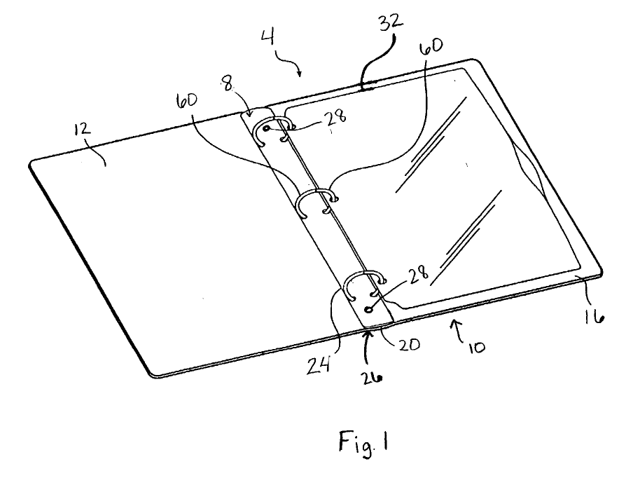

FIG. 1 illustrates a ring binder 4 incorporating a ring mechanism 8 of the present invention. The ring binder 4 includes a flat 10 having front panel 12 and a rear panel 16. As shown in the illustrated embodiment, the front and rear panels 12, 16 are coupled by a spine 20. It should be understood that in other embodiments of a ring binder, the front and rear panels 12, 16 may be coupled together directly without the use of a spine. The ring mechanism 8 includes a plastic or metallic chassis 24 that is coupled to a mounting surface 26 of the flat 10 by at least one post 28. In the illustrated embodiment, the mounting surface 26 is the spine 20 of the binder 4.

As illustrated in FIG. 1, a plurality of posts 28 could also be used. The post 28 may be a rivet or other suitable fastener. As shown in FIG. 1, the binder 4 may be used to secure a folder 32 within the binder 4. It is understood that the binder 4 may also be used to secure a sheet, a file, or the like.

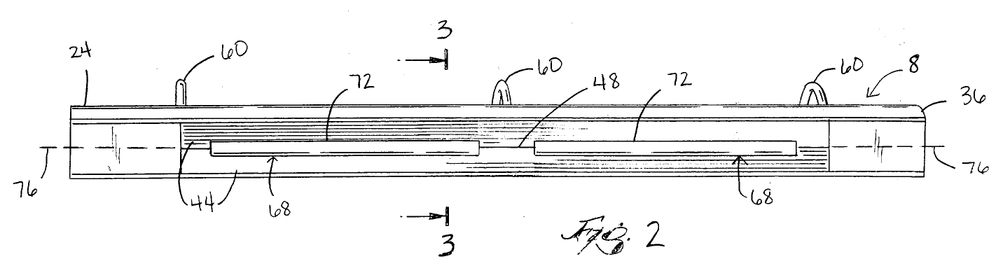

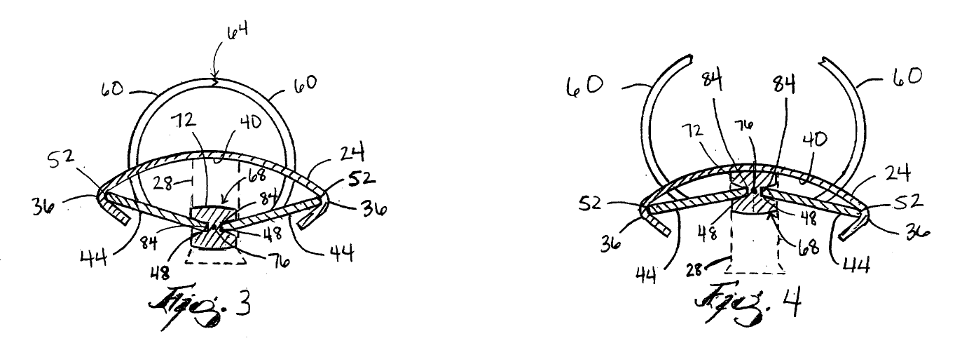

FIGS. 2-4 illustrate the ring mechanism 8 of the ring binder 4 in more detail. As best shown in FIGS. 3 and 4, the chassis 24 has crimped or bent edges 36 and an inner surface 40 extending between the crimped edges 36.

The ring mechanism 8 further includes at least one hinge blade 44 coupled to the chassis 24. In the embodiments illustrated in FIGS. 2-10, two hinge blades 44 are coupled to the chassis 24. However, one of skill in the art would understand that in some embodiments, the ring mechanism 8 may include only one hinge blade. Each hinge blade 44 has an inner edge 48 and an outer edge 52. The hinge blades 44 are coupled to the chassis 24 such that the crimped edges 36 of the chassis 24 are folded over the respective outer edges 52 of the hinge blades 44. As the ring mechanism 8 is opened and closed (see FIGS. 3 and 4), the hinge blades 44 pivot about their respective outer edges 32 such that the inner edges 48 move toward or away from the inner surface 40. The hinge blades 44 pivot from a first or closed position (see FIG. 3) to a second or open position (see FIG. 4).

The ring mechanism 8 further includes at least one ring half 60 coupled to each hinge blade 44. Together, the ring halves 60 define a substantially closed ring 64 that can be opened or closed. In the embodiments where only one hinge blade is present in the ring mechanism, at least one ring half 60 is coupled to the hinge blade and a corresponding ring half 60 is coupled to the chassis such that the corresponding ring halves still define a substantially closed ring. As illustrated in FIGS. 3 and 4, the ring halves 60 are closed when the hinge blades 44 are in the first position and the ring halves 60 are open when the hinge blades 44 are in the second position. As illustrated in FIG. 2, the hinge blades 44 each include three ring halves 60, but it should be understood that any number of ring halves 60 may be coupled to the hinge blades 44.

A sound deadening mechanism in the form of a dampening member 68 is positioned within the ring mechanism 8 to decrease the sound made by the ring mechanism 8 when moving from the closed to the open position and back again. The dampening member 68 is positioned between the inner surface 40 of the chassis 24 and the mounting surface 26 of the flat 10. In the embodiments illustrated in FIGS. 1-6, the dampening member 68 is positioned at least partially between the inner surface 40 of the chassis 24 and the hinge blades 44 to prevent direct engagement between the hinge blades 44 and the inner surface 40 that would cause noise in the operation of the ring mechanism 8. The dampening member 68 can be formed of rubber, plastic, elastomeric material, or any other suitable material.

In the embodiment illustrated in FIG. 2, the dampening member 68 is one or more longitudinally extending rails or I-shaped beams 72 placed along a longitudinal hinge axis 76 extending between the inner edges 48 of the hinge blades 44. The rail 72 defines longitudinally extending grooves 84 for receiving the inner edges 48 of the hinge blades 44. The grooves 84 are configured to accommodate the different positions of the inner edges 48 of the hinge blades 44 as the hinge blades 44 move between the closed and open positions. The rail 72 acts as a buffer between the hinge blades 44 and the inner surface 40 of the chassis 24 to prevent direct engagement between the inner edges 48 of the hinge blades 44 and the inner surface 40 of the chassis 24, thereby deadening the sound generated in the ring mechanism 8 when the hinge blades 44 are moved from the closed to the open position.

FIG. 3 illustrates the ring mechanism 8 in the closed position. FIG. 4 illustrates the ring mechanism 8 in the open position. The rail 72 is positioned along the longitudinal axis 76 between the hinge blades 44 to decrease the sound made when opening and closing the mechanism 8.

When the ring mechanism 8 is opened, as in FIG. 4, the upper surface of the rail 72 engages the inner surface 40 of the chassis 24, preventing the inner edges 48 of the hinge blades 44 from directly engaging the inner surface 40 of the chassis 24. Because the rail 72 prevents direct metal-to-metal engagement, the noise generated by opening the ring mechanism 8 is greatly reduced or eliminated when the ring mechanism 8 is opened.

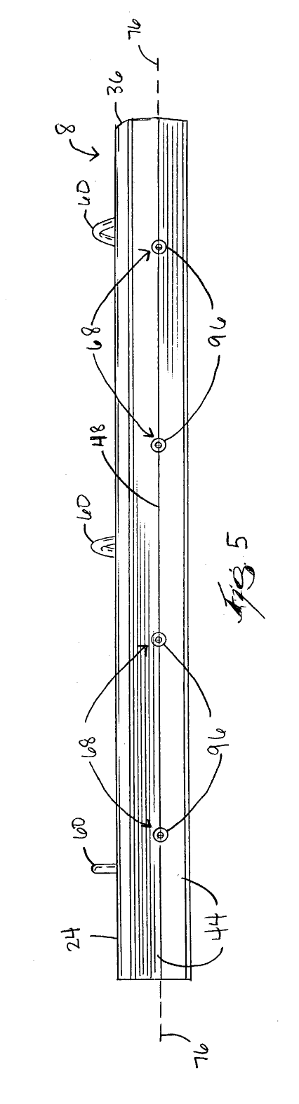

FIG. 5 illustrates another embodiment of the invention wherein the dampening member 68 is a plurality of generally cylindrical rubber grommets 96. The grommets 96 ride between the inner edges 48 of the hinge blades 44 along the longitudinal axis 76 and act as a bumper at the top of the path of travel of the hinge blades 44 when the ring mechanism 8 is opened. The grommets 96 prevent the inner edges 48 of the hinge blades 44 from engaging the inner surface 40 of the chassis 24. Again, it is understood that the dampening member 68 could be one or a plurality of grommets 96.

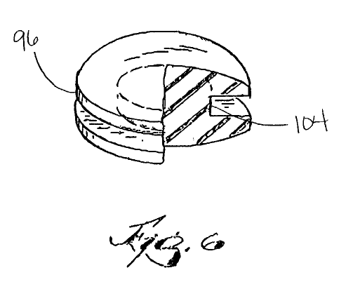

FIG. 6 illustrates the grommet 96 in more detail. The grommet 96 defines a circumferential groove 104 for receiving the inner edges 48 of the hinge blades 44. In a similar manner to the rail 72 described above, the grommet 96 acts as a buffer between the hinge blades 44 and the inner surface 40 of the chassis 24 to prevent direct engagement between the inner edges 48 of the hinge blades 44 and the inner surface 40 of the chassis 24, thereby deadening the sound generated in the ring mechanism 8 when the hinge blades 44 are moved from the closed to the open position.

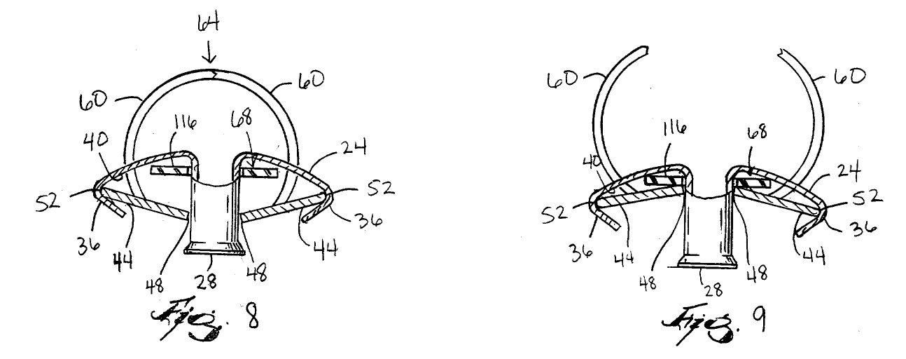

In another embodiment of the invention, as shown in FIG. 7, the dampening member 68 is a rubber washer 116 coupled to the mounting post 28 between the chassis 24 and the hinge blades 44 to act as a bumper between the chassis 24 and the hinge blades 44. It is understood that the dampening member 68 of this embodiment could be a washer, an o-ring, a washer-like object, a gel cylinder or an air cylinder. Due to the presence of the washer 116, the inner edges 48 of the hinge blades 44 do not directly engage with the inner surface 40 of the chassis 24 upon opening of the ring mechanism 8 (best shown in FIG. 9). Where multiple posts 28 are used to couple the chassis 24 to the spine 20 of the binder 4, a washer 116 can be coupled to each post 28. A plurality of washers 116 on each post 28 can also be used to further reduce or eliminate sound.

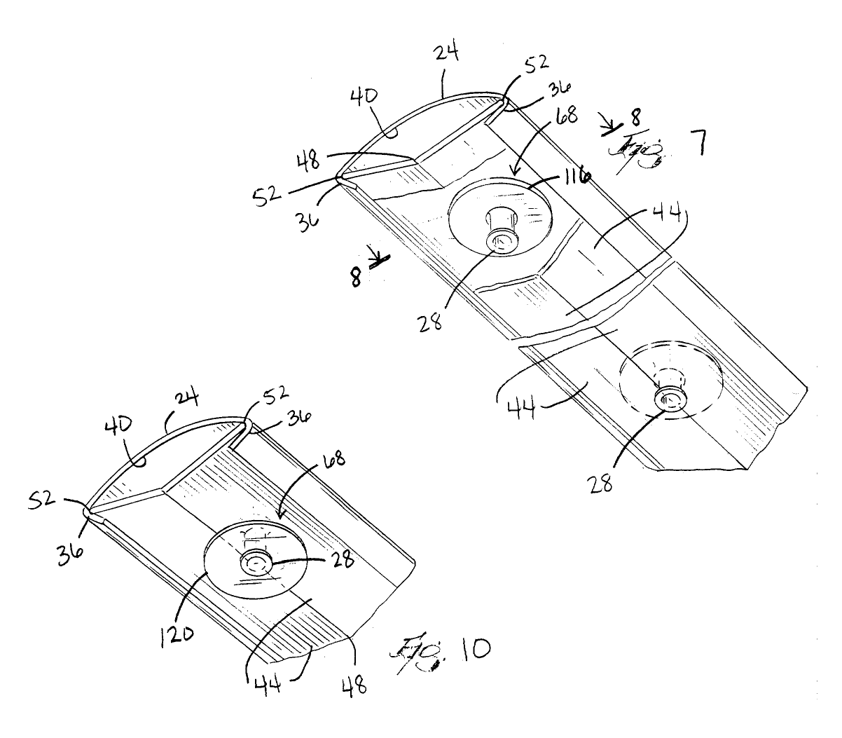

FIG. 8 illustrates the ring mechanism 8 of FIG. 7 in the first, or closed, position. FIG. 9 illustrates the ring mechanism 8 of FIG. 7 in the second, or open, position.

FIG. 10 illustrates another embodiment of FIG. 7, wherein a lower washer 120 is coupled to the post 28, this time between the hinge blades 44 and the spine 20 of the binder 4 (not shown in FIG. 10) to deaden the sound made when the ring mechanism 8 goes from the open to the closed position. The washer 120 acts to further muffle the sound when the ring mechanism 8 moves between the open and closed positions. This lower washer 120 could be used alone, or in combination with the washer 116 of FIG. 7.

While three specific embodiments of dampening members 68 have been described above in relation to the present invention, it is understood that other configurations of dampening members 68 could be used without deviating from the spirit of the present invention. For example, the dampening member 68 could be a rubber block coupled to the inner surface 40 of the chassis 24, an elastomeric spring, an inflated plastic disk coupled to the inner surface 40 of the chassis 24, or a gel or liquid filled member coupled to the inner surface 40 of the chassis 24, all of which would act as a buffer between the hinge blades 44 and the inner surface 40 of the chassis 24.

Various features of the invention are set forth in the following claims.

1. A ring mechanism comprising:
a chassis having an inner surface;
a hinge blade coupled to the chassis, the hinge blade being movable between a first position and a second position;
a ring half coupled to the hinge blade, the ring half being movable between a closed position when the hinge blade is in the first position, and an open position when the hinge blade is in the second position; and
a dampening member positioned at least partially between the inner surface of the chassis and the hinge blade so that at least a portion of the hinge blade is substantially prevented from directly engaging the inner surface of the chassis.

2. The ring mechanism of claim 1, wherein the ring mechanism includes two hinge blades, and wherein the hinge blades are hinged about a hinge axis, and wherein the dampening member is at least partially positioned on the hinge axis.

3. The ring mechanism of claim 1, wherein the dampening member is a longitudinally extending member having a longitudinally extending groove.

4. The ring mechanism of claim 1, wherein the dampening member is a generally cylindrical member having a circumferential groove.

5. The ring mechanism of claim 1, wherein the dampening-member is one of a plurality of dampening members.

6. The ring mechanism of claim 1, further comprising a post coupled to the chassis, and wherein the dampening member is coupled to the post.

7. The ring mechanism of claim 6, wherein the dampening member is a washer.

8. The ring mechanism of claim 1, wherein the dampening member comprises rubber.

9. The ring mechanism of claim 1, wherein the dampening member comprises plastic.

10. A binder comprising:
a flat having a front panel and a rear panel coupled to the front panel; and
a ring mechanism coupled to the flat at a mounting surface of the flat, the ring mechanism including,
a chassis having an inner surface,
a hinge blade coupled to the chassis and movable between a first position and a second position,
a ring half coupled to the hinge blade, the ring half being movable between a closed position when the hinge blade is in the first position, and an open position when the hinge blade is in the second position, and
a dampening member positioned between the inner surface of the chassis and the mounting surface of the flat so that at least a portion of the hinge blade is substantially prevented from directly engaging the inner surface of the chassis.

11. The binder of claim 10, wherein the dampening member is positioned at least partially between the inner surface of the chassis and the hinge blade to prevent at least a portion of the hinge blade from directly engaging the inner surface of the chassis.

12. The binder of claim 10, wherein the dampening member is positioned at least partially between the mounting surface of the flat and the hinge blade.

13. The binder of claim 10, wherein the ring mechanism includes two hinge blades, and wherein the hinge blades are hinged about a hinge axis, and wherein the dampening member is at least partially positioned on the hinge axis.

14. The binder of claim 10, wherein the dampening member is a longitudinally extending member having a longitudinally extending groove.

15. The binder of claim 10, wherein the dampening member is a substantially cylindrical member having a circumferential groove.

16. The binder of claim 10, wherein the dampening member is one of a plurality of dampening members.

17. The binder of claim 10, further comprising a post coupling the ring mechanism to the flat of the binder, and wherein the dampening member is coupled to the post.

18. The binder of claim 17, wherein the dampening member is a washer.

19. The binder of claim 10, wherein the dampening member comprises rubber.

20. The binder of claim 10, wherein the dampening member comprises plastic.

21. A method of dampening sound in a ring mechanism for use with a binder, the binder having a flat including a front panel coupled to a rear panel, the ring mechanism coupled to the flat at a mounting surface of the flat, the ring mechanism further having a chassis with an inner surface, a hinge blade coupled to the chassis and movable between a first position and a second position, and a ring half coupled to the hinge blade, the ring half being movable between a closed position when the hinge blade is in the first position, and an open position when the hinge blade is in the second position, the method comprising:
positioning a dampening member between the inner surface of the chassis and the mounting surface of the flat; and
moving the hinge blade between the first and second positions so that the dampening member substantially prevents at least a portion of the hinge blade from directly engaging the inner surface of the chassis when the hinge blade is moved to at least one of the first and second positions.

22. The method of claim 21, wherein positioning the dampening member between the inner surface of the chassis and the mounting surface of the flat includes positioning the dampening member at least partially between the inner surface of the chassis and the hinge blade.

23. The method of claim 21, wherein positioning the dampening member between the inner surface of the chassis and the mounting surface of the flat includes positioning the dampening member at least partially between the mounting surface of the flat and the hinge blade.

24. The method of claim 21, wherein positioning the dampening member between the inner surface of the chassis and the mounting surface of the flat includes positioning a plurality of dampening members between the inner surface of the chassis and the mounting surface of the flat.

25. The method of claim 21, wherein the ring mechanism includes two hinge blades, and wherein positioning the dampening member includes placing the dampening member at least partially on a hinge axis formed between the two hinge blades.

26. The method of claim 21, wherein moving the hinge blade between at least one of the first and the second positions includes compressing the dampening member.
